(19) United States
(12) Patent Application Publication
(10) Pub. No.: US 2009/0309382 A1
(43) Pub. Date: Dec. 17, 2009

(54) Slide-Out Mechanism

(76) Inventors: Charles R. Moore, Mishawaka, IN (US); Darrel Schramski, Mishawaka, IN (US); Timothy D. Schultz, Mishawaka, IN (US); Craig Wisner, Wauwatosa, WI (US)

Correspondence Address: QUARLES & BRADY LLP, 411 E. WISCONSIN AVENUE, SUITE 2040, MILWAUKEE, WI, 53202-4497, US

(21) Appl. No.: 12/411,099

(22) Filed: Mar. 25, 2009

Related U.S. Application Data
(60) Provisional application No. 61/039,327, filed on Mar. 25, 2008.

(51) Int. Cl. B60P 3/34; F16H 25/18

(52) U.S. Cl. 296/26.13; 74/89.17

(57) ABSTRACT

An operating mechanism for laterally moving a slide-out section relative to a vehicle between a retracted position and an extended position includes a rack and pinion assembly mounted to a frame. The pinion preferably has a non-round hole through which a non-round drive shaft is received in driving engagement. The pinion is received in a channel with sides of the channel adjacent to the sides of the pinion. The pinion floats axially on the drive shaft and the sides of the channel maintain the axial position of the pinion on the drive shaft. The shape of the drive shaft and the hole in the pinion is preferably square.

### CROSS-REFERENCE TO RELATED APPLICATION

This application claims benefit to U.S. Provisional Application No. 61/039,327 filed on Mar. 25, 2008.

### STATEMENT CONCERNING FEDERALLY SPONSORED RESEARCH OR DEVELOPMENT

Not applicable.

### FIELD OF THE INVENTION

This invention relates to vehicles having extendable sections, and more particularly to an operating mechanism for moving a slide-out section of a vehicle between extended and retracted positions relative to the vehicle.

### BACKGROUND OF THE INVENTION

In order to increase the available interior space of recreational vehicles (trailers or motor homes), it is known to provide a slide-out section (such as a bedroom) as part of the structure of the vehicle. A slide-out section is a raised platform enclosed on all sides except one. Typically, the inner side is the open side, for access to the slide-out section from inside the vehicle. During transit, the slide-out section is retracted and stored in the interior of the vehicle, with the exterior wall of the slide-out section approximately flush with the exterior of the vehicle or trailer. To use the slide-out section after the vehicle is parked and leveled, it is slid outward from the vehicle to an extended position, thereby increasing the interior space of the vehicle.

The operating mechanism for moving slide-out sections are typically devised to push the slide-out section away from the vehicle when extending the slide-out section, and pull the slide-out section toward or into the vehicle when retracting the slide-out section. The mechanism for moving the slide-out section relative to the vehicle is fixed to the vehicle body and can include one or more sliding rails attached to the slide-out section. Typically, these sliding rails slide within rail supports fixed to the vehicle frame. Multiple sliding rails are typically utilized for wide slide-out sections. The sliding rails may be driven by a single drive unit. Thus, in mechanisms having two sets of sliding rails, both sets are directly driven by a drive unit, for example by one shaft with two pinion gears on it, one gear for each set. In other designs, the sliding rails are driven independently of each other. The motion of the sliding rails is preferably synchronized to prevent the slide-out section from becoming skewed or binding relative to the vehicle. There is a need for a slide-out operating mechanism that is adaptable to different vehicle and drive configurations and is easy to make, assemble and repair.

### SUMMARY OF THE INVENTION

The present invention provides an operating mechanism for laterally moving a slide-out section relative to a vehicle between a retracted position and an extended position. The operating mechanism includes a rack and pinion assembly mounted to a frame to move the slide-out section between the retracted and extended positions. The pinion preferably has a non-round hole through which a non-round drive shaft is received in driving engagement.

The pinion may be received in a channel with sides of the channel adjacent to the sides of the pinion. The pinion can float axially on the drive shaft and the sides of the channel maintain the axial position of the pinion on the drive shaft. The shape of the drive shaft and the hole in the pinion are preferably non-round, for example, square.

In another aspect of the invention, the operating mechanism preferably includes outer bearings that snap fit with inner bearings. The outer bearings are preferably received in holes in the frame. The inner bearings are preferably located at the sides of the pinion and each has a non-round hole that receives the drive shaft. In addition, the inner bearings preferably snap fit with the drive shaft to retain them axially relative to each other.

In another aspect of the invention, the operating mechanism includes a top rail that preferably includes rails that define side outwardly opening channels. The side outwardly opening channels may receive guide rollers. The top rail of the mechanism is preferably an extruded component.

The foregoing and other objects and advantages of the invention will appear in the detailed description that follows. In the description, reference is made to the accompanying drawings that illustrate a preferred embodiment of the invention.

### BRIEF DESCRIPTION OF THE DRAWINGS

FIG. 1 is a side view of a vehicle floor having a slide-out section incorporating the slide-out section operating mechanism of the present invention;

FIG. 2 is an exploded view of the mechanism of FIG. 1;

FIG. 3 is a partially exploded view of the mechanism of FIG. 1;

FIG. 4 is a section view of a frame section of the mechanism taken along line 4-4 of FIG. 3;

FIG. 5a is a side view of a drive shaft of the mechanism of FIG. 1;

FIG. 5b is a front plan view of the drive shaft of FIG. 5a;

FIG. 6a is a front plan view of an inner bearing of the mechanism of FIG. 1;

FIG. 6b is a side view of the inner bearing of FIG. 6a;

FIG. 7a is a front plan view of an outer bearing of the mechanism of FIG. 1;

FIG. 7b is a side view of the outer bearing of FIG. 7a;

FIG. 8a is a front plan view of a pinion of the mechanism of FIG. 1;

FIG. 8b is a side view of the pinion of FIG. 8a;

FIG. 9 is a side view of a drive motor assembly of the mechanism of FIG. 1;

FIG. 10 is a partial sectional view of the mechanism taken along line 10-10 of FIG. 1;

FIG. 11 is a front plan view of a top rail of the mechanism of FIG. 1;

FIG. 12 is a top view of the top rail of FIG. 11;

FIG. 13a is a front plan view of an outer bearing snapped to a side bracket;

FIG. 13b is a front plan view of an inner bearing snapped to the outer bearing of FIG. 13a; and

FIG. 13c is a front plan view of a drive shaft being snapped to the inner bearing of FIG. 13b.

### DETAILED DESCRIPTION OF THE PREFERRED EMBODIMENT

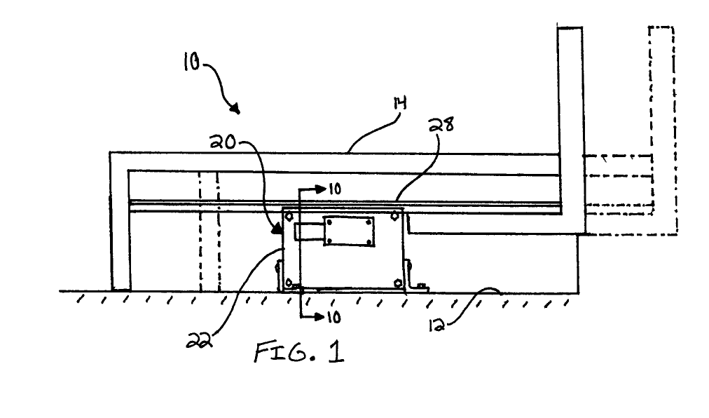

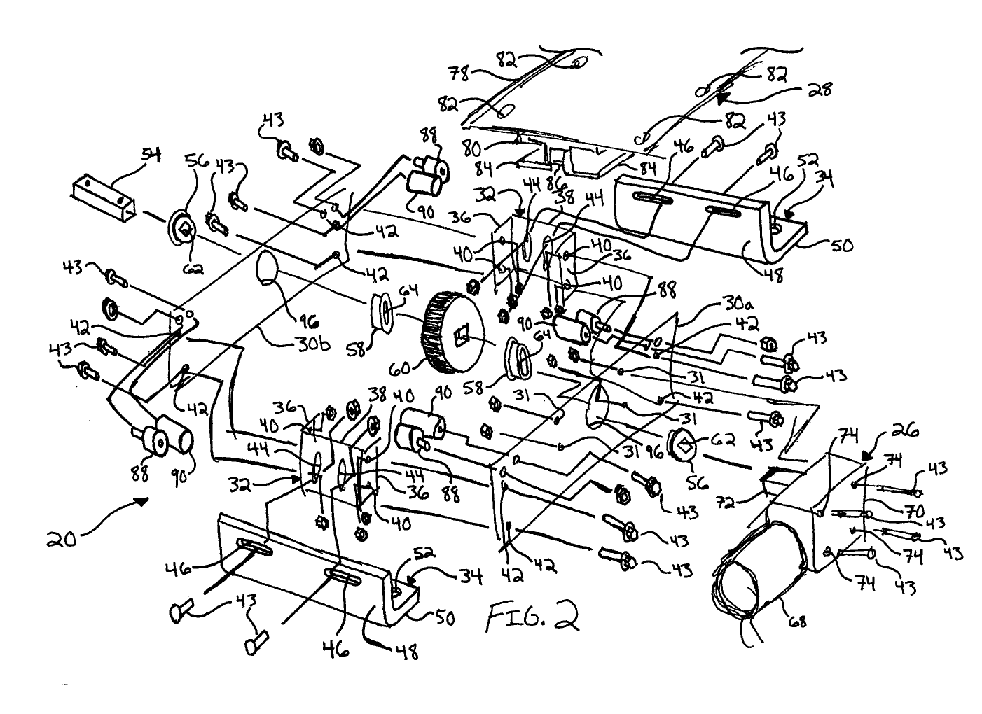

Referring to FIG. 1, a slide-out section 10 is mounted to a vehicle floor 12. The slide-out section 10 has a movable platform 14 mounted to a top rail 28. The top rail 28 is movably mounted to a frame section 22 that is fixed to the vehicle floor 12. The top rail 28 and the frame section 22 are part of a slide-out section operating mechanism 20 that moves the slide-out section 10 between extended and retracted positions. This motion is achieved by a rack and pinion drive in the slide-out section operating mechanism 20. Alternatively, multiple slide-out section operating mechanisms 20 may be used to move the slide-out section 10 between extended and retracted positions.

Referring to FIGS. 2 and 3, the slide-out section operating mechanism 20 according to the present invention includes the frame section 22, a drive shaft assembly 24, a drive motor assembly 26, and the top rail 28. It should be noted that several components are not shown in FIG. 3, such as the top rail, so that other components are not obstructed. The frame section 22 includes side brackets 30a and 30b, end brackets 32, and angle brackets 34. The brackets 30a, 30b, 32, and 34 are preferably formed of steel sheet metal. The side brackets 30a and 30b differ in that the side bracket 30a includes motor mounting holes 31. Alternatively, the side brackets 30a and 30b may be identical to reduce the number of types of components in the assembly. Each end bracket 32 includes two end sections 36 formed generally perpendicularly from a main section 38. Each section 36 includes bracket mounting holes 40 that align with bracket mounting holes 42 on the side brackets 30a and 30b. The end brackets 32 are fixed to the side brackets 30a and 30b by passing fasteners 43 through the bracket mounting holes 40 and 42. The fasteners 43 may be sets of bolts and nuts. The main section 38 of each end bracket 32 includes angle bracket mounting holes 44 that align with bracket mounting holes 46 on the angle brackets 34. Each angle bracket 34 includes a first section 48 and a second section 50, the second section 50 extending generally perpendicularly from the first section 48. Each second section 50 of the angle brackets 34 includes a plurality of holes 52. Fasteners may be passed through these holes 52 to secure the angle brackets 34 to the vehicle. The holes 40, 42, 44, 46, and 52 may be sized as appropriate for the fasteners selected to secure the aforementioned components.

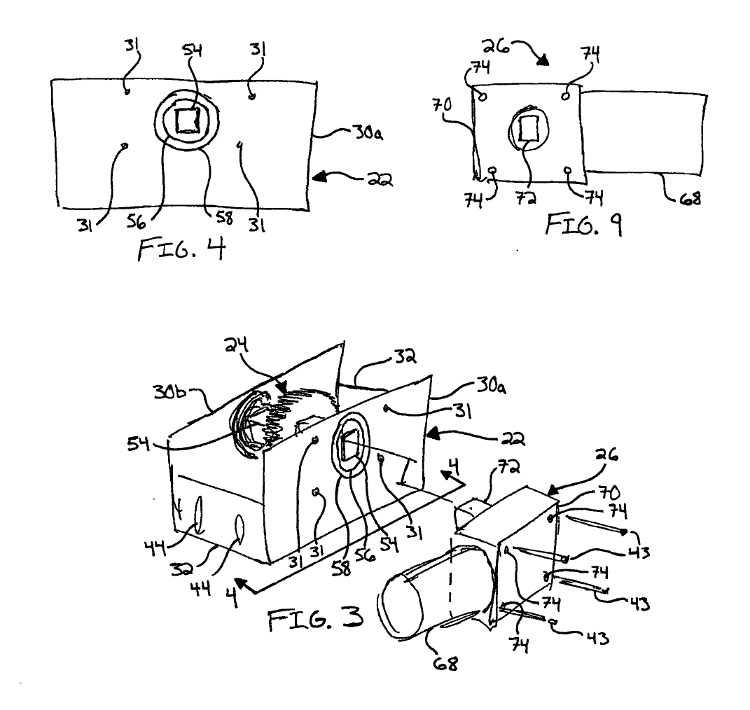

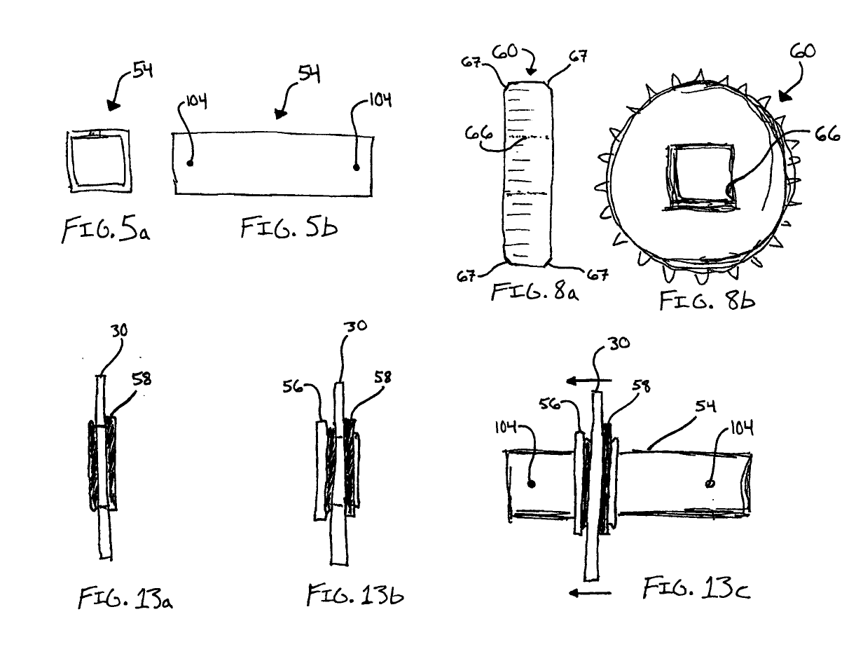

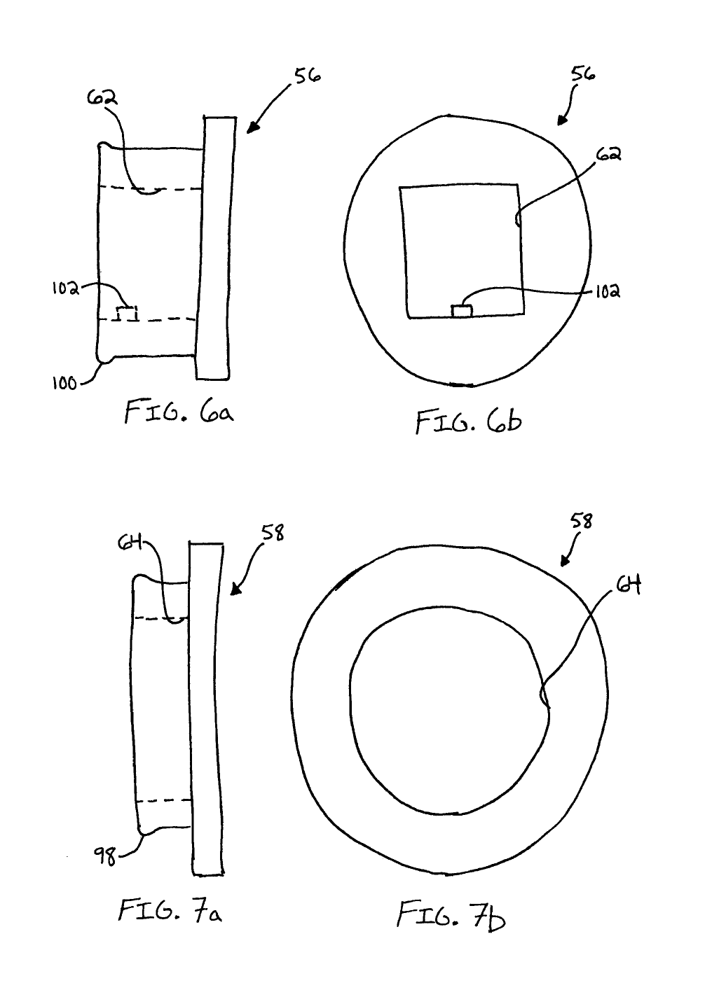

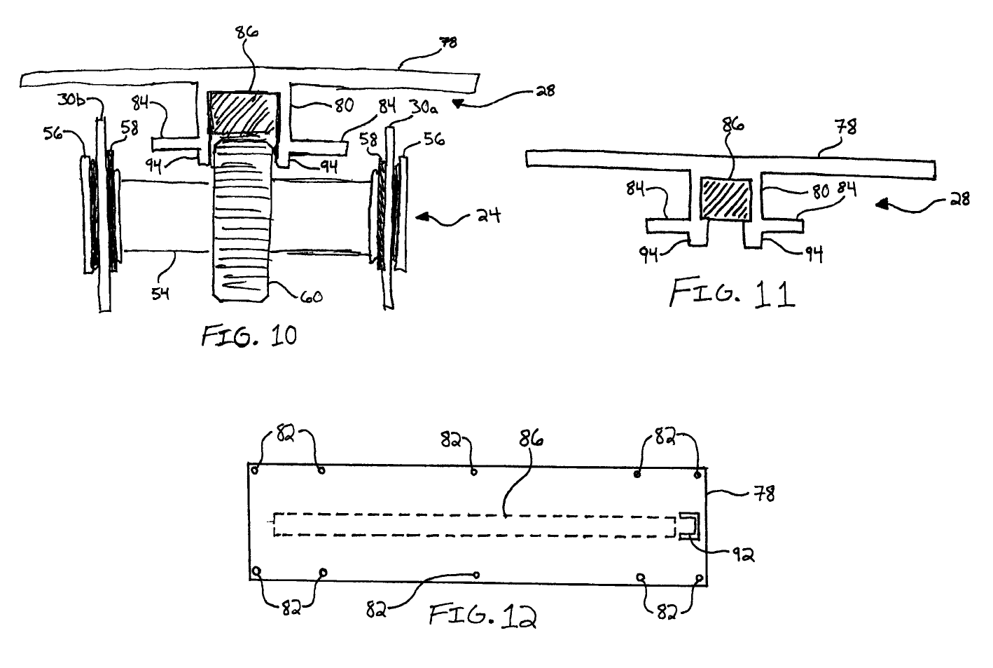

The drive shaft assembly 24, as shown in FIGS. 2 and 3, includes a drive shaft 54, inner bearings 56, outer bearings 58, and a pinion 60. Referring to FIGS. 5a and 5b, the drive shaft 54 is preferably made from square tube stock. The ends of the drive shaft 54 are preferably flush with the side brackets 30a and 30b when the mechanism 20 is assembled, as shown in FIG. 3. Referring to FIGS. 6a and 6b, the inner bearings 56 are preferably flange bearings with square internal holes 62 that receive the drive shaft 54. Referring to FIGS. 7a and 7b, the outer bearings 58 are preferably flange bearings with round internal holes 64 that receive the inner bearings 56. The inner bearings 56 and the outer bearings 58 are preferably made from a well known plastic suitable for bushings or bearings, such as an acetal. Additional details of the aforementioned drive shaft assembly 24 components will be described in further detail below.

Referring to FIGS. 8a and 8b, the pinion 60 includes a square internal hole 66 that receives the drive shaft 54 in driving engagement. The pinion 60 preferably includes beveled edges 67 as shown in FIG. 8a. The tooth parameters, such as pitch diameter, number of teeth, and pressure angle, may be selected as appropriate for the specific dimensions and power requirements of different designs.

The drive motor assembly 26, as shown in FIGS. 2, 3, and 9, includes a motor 68, a gearbox 70, and an output shaft 72. The motor 68 may be any motor that meets the power requirements to move the slide-out section. The gearbox 70 may be a worm gear drive, a bevel gear drive, or the like. Alternatively, the gearbox 70 may be a non-right angle drive if there is sufficient space for the drive motor assembly 26. The output shaft 72 preferably has a square cross sectional area and is received in the hollow drive shaft 54. The output shaft 72 and the internal section of the drive shaft 54 may have alternative shapes, such as a hexagonal shape or a spline shape, provided that the output shaft 72 is in driving engagement with the drive shaft 54. The gear box 70 includes mounting holes 74 through which fasteners 43 secure the drive motor assembly 26 to the side bracket 30a. The fasteners 43 also pass through motor mounting holes 31 on the side bracket 30a.

The top rail 28, as shown in FIGS. 2, 10, and 11, includes a top section 78 and a rack section 80. The top section 78 is a generally flat and can be made of steel plate or sheet metal. The top section includes a plurality of holes 82 through which the mechanism 20 is attached to the movable platform 14 of the vehicle. The rack section 80 is located below the top section 78 and includes rails 84 and a rack 86. The rails 84 define side outwardly opening channels that receive guide rollers 88 and wear buttons 90 attached to the side brackets 30a and 30b. The guide rollers 88 support the top rail 28 and the wear buttons 90 prevent the top rail 28 from skewing relative to the vehicle. The rack 86 is located between the rails 84. The rack 86 may be fixed to the top section 78 by fasteners, adhesives, or captured in a slot as shown in FIG. 11. When the rack 86 is captured as shown in FIG. 11, with shoulders of the slot below the rack on each side of the channel into which the pinion 60 extends holding the rack in the slot, the rack 86 may be slid into the slot from one end or the other longitudinally. Additionally, the rack 86 may be held longitudinally by forming a weld bead on the rack section 80 near the rack 86, using fasteners or adhesives, or by forming a foldable tab 92 in the top section 78 as shown in FIG. 12. As shown in FIG. 10, the rack 86 engages the pinion 60 in a channel formed by two sides 94 of the rack section 80. The sides 94 ensure the pinion 60 remains centered as it floats on the drive shaft 54. Advantageously, additional components, such as pins or keyways, are not needed to hold the pinion 60 in place on the shaft 54.

The top rail 28 may include adjustable stops (not shown) on the ends of the rails 84. These adjustable stops limit the range of motion of the top rail 28 relative to the frame section 22. When the slide-out section is a room, it is important that the room extends and retracts to specific locations. If the room is not positioned at specific locations, the room may not form a proper seal with the vehicle, or the room may contact the vehicle when moving to the retracted position.

The top section 78 and the rack section 80 of the top rail 28 are preferably aluminum. In addition, the top rail 28 (except for the rack 86) is preferably a single component formed by an extrusion process.

The assembly process for connecting the bearings 56 and 58 and the drive shaft 54 is as follows. The outer bearing 58 is snapped in a bearing hole 96 (as best shown in FIG. 2) on one of the side brackets 30 as shown in FIG. 13a. As shown in FIG. 7a, the outer bearing 58 includes a lip 98 to prevent the outer bearing 58 from falling out of the hole 96. Next, the inner bearing 56 is snapped in the round internal hole 64 of the outer bearing 58 as shown in FIG. 13b. As shown in FIG. 6a, the inner bearing 56 includes a lip 100 to prevent the inner bearing 56 from falling out of the outer bearing 58. Next, the drive shaft 54 is snapped in the square internal hole 62 of the inner bearing 56 as shown in FIG. 13c. As shown in FIGS. 6a and 6b, the inner bearing 56 includes a nub 102 that engages a hole 104 in the drive shaft 54. The nub 102 and the hole 104 secure the inner bearing 56 and the drive shaft 54 relative to each other. Alternatively, the nub 102 of the inner bearing 56 could be a spring finger. The hole 104 in the drive shaft 54 on the right side of FIG. 13c engages the nub of the inner bearing on the opposite side of the mechanism (not shown). Advantageously, additional components, such as pins, are not needed to hold the bearings 56 and 58 in place relative to the drive shaft 54.

A preferred embodiment of the invention has been described in considerable detail. Although some attention was given to various alternatives within the scope of the invention, it is anticipated that one skilled in the art will likely realize alternatives that are now apparent from disclosure of embodiments of the invention. Accordingly, the scope of the invention should be determined from the following claims and not limited by the above disclosure.

We claim:

1. An operating mechanism for laterally moving a slide-out section relative to a vehicle between a retracted position and an extended position, the operating mechanism comprising:
a frame attached to the vehicle;
a rack and pinion assembly mounted to the frame to move the slide-out section from the retracted position to the extended position;
wherein the pinion has a non-round hole through which a non-round hollow drive shaft is received in driving engagement so the pinion floats axially on the drive shaft and the rack is received in a channel with sides of the channel adjacent to sides of the pinion where the pinion engages the rack so as to maintain the axial position of the pinion on the drive shaft.

2. The mechanism of claim 1, wherein the drive shaft and the hole in the pinion are rectangular.

3. The mechanism of claim 2, wherein the drive shaft and the hole in the pinion are square.

4. The mechanism of claim 1, wherein inner bearings at sides of the pinion each have a non-round hole that receives the drive shaft.

5. The mechanism of claim 4, wherein the inner bearings are received in outer bearings that are received in holes in the frame.

6. The mechanism of claim 5, wherein the inner bearings and the outer bearings snap fit together to retain them axially relative to one another.

7. The mechanism of claim 5, wherein the inner bearings and the drive shaft snap fit together to retain them axially relative to one another.

8. The mechanism of claim 1, wherein a motor output shaft is non-round and fits in an end of the drive shaft and is in driving engagement with the drive shaft.

9. The mechanism of claim 1, wherein a top rail of the mechanism is an extruded component.

10. The mechanism of claim 1, wherein a top rail of the mechanism includes rails that define side outwardly opening channels in which guide rollers are received.

11. The mechanism of claim 1, wherein the mechanism is located above the floor of the vehicle.

12. The mechanism of claim 1, wherein the rack is captured by a top rail of the mechanism.

13. The mechanism of claim 12, wherein the rack is supported in the longitudinal direction of the top rail by a foldable tab formed on the top rail.

14. An operating mechanism for laterally moving a slide-out section relative to a vehicle between a retracted position and an extended position, the operating mechanism comprising:
a frame attached to the vehicle;
a rack and pinion assembly mounted to the frame to move the slide-out section from the retracted position to the extended position;
wherein the pinion is in driving engagement with a hollow drive shaft that is supported by inner bearings and outer bearings at sides of the pinion and the inner bearings and the outer bearings snap fit together to retain them axially relative to one another.

15. The mechanism of claim 14, wherein the inner bearings and the drive shaft snap fit together to retain them axially relative to one another.

16. The mechanism of claim 14, wherein the pinion has a non-round hole and the drive shaft is non-round.

17. The mechanism of claim 16, wherein a motor output shaft is non-round and fits in an end of the drive shaft and is in driving engagement with the drive shaft.

18. The mechanism of claim 16, wherein the drive shaft and the hole in the pinion are rectangular.

19. The mechanism of claim 18, wherein the drive shaft and the hole in the pinion are square.

20. The mechanism of claim 14, wherein a top rail of the mechanism is an extruded component.

21. The mechanism of claim 14, wherein a top rail of the mechanism includes rails that define side outwardly opening channels in which guide rollers are received.

22. The mechanism of claim 14, wherein the mechanism is located above the floor of the vehicle.

23. The mechanism of claim 14, wherein the rack is captured by a top rail of the mechanism.

24. The mechanism of claim 14, wherein the inner bearings and the outer bearings are a plastic material.

25. The mechanism of claim 24, wherein the inner bearings and the outer bearings are an acetal plastic.
